(19) United States
(12) Patent Application Publication
(10) Pub. No.: US 2006/0065679 A1
(43) Pub. Date: Mar. 30, 2006

(54) Watering jug for plants

(76) Inventor: Steve Gregory, Howell, MI (US)

Correspondence Address: LITMAN LAW OFFICES, LTD, PO BOX 15035, CRYSTAL CITY STATION, ARLINGTON, VA, 22215, US

(21) Appl. No.: 10/622,586

(22) Filed: Jul. 21, 2003

(51) Int. Cl. B67D 5/06

(52) U.S. Cl. 222/482; 222/185.1

(57) ABSTRACT

A watering jug for plants having a valve with a pin sized hole for delivering trickling water. The container may have legs or support feet for orienting the watering jug in an upright position above the soil, and may be sized to provide a gentle slope to the container to assist the flow of water. A valve with a simple twist type mechanism for opening and closing is provided at the bottom of the jug. The watering jug is lightweight and portable.

### BACKGROUND OF THE INVENTION

1. Field of the Invention

The present invention relates to watering cans or jugs, and more particularly to a trickle jug having a spout and valve for limiting the flow of water, for thoroughly soaking the soil around a plant while using a minimum amount of water for maximum results.

2. Description of the Related Art

Containers, cans or jugs of different sizes and shapes including valve for controlling the flow of water for watering plants in pots and garden have been the subject of related patents. For example:

U.S. Pat. No. 1,453,401, issued May 1, 1923 to Mattson, discloses a plant irrigator for dispensing water in any desired volume for watering a plurality of plants without any attention from the user.

U.S. Pat. No. 4,115,951, issued Sep. 26, 1978 to Becker et al., describe an apparatus for feeding a continuous supply of liquid to the soil surrounding potted plants. It includes a soil probe with variable aperture for moisturizing the soil in the potted plants.

U.S. Pat. No. 5,076,009, issued Dec. 31, 1991 to Cibor, describes a water supply system including tubing connected to a sealed float valve assembly for feeding water to a Christmas tree stand having a reservoir.

U.S. Pat. No. 5,806,240; issued Sep. 15, 1998 to Racine, describes a system for supplying dripping water to plants comprises a support for holding the container upright over the soil to be watered. It includes a tube for feeding water and a screw valve to limit the volume of water.

U.S. Pat. No. 6,185,866 B1, issued Feb. 13, 2001 to Enfaradi, describes a transparent water container having a drip hose and clamp at the bottom, for regulating the flow of water.

None of the above inventions and patents, taken either singly or in combination, is seen to describe the instant invention as claimed. Thus a watering jug for plants solving the aforementioned problems is desired.

### SUMMARY OF THE INVENTION

The invention is a watering jug with a capacity ranging from 1 to 2 gallons. The container is made of plastic, metal or ceramic. The container is oval shaped and includes a handle at top. The container top includes a small opening in the center below the handle for filling the jug and a delivery pipe and valve combination located at the bottom of the container for regulating the flow of water. The delivery pipe and valve combination includes a small pin-sized opening for producing a trickling of water in the soil around a plant in the pot or in a garden for a period during which the plant cannot be attended. The delivery pipe and valve combination includes a twist type mechanism for closing and opening the pin-sized opening. The container may include legs at the bottom for providing stability to the water filled container when placed on uneven surface. The container bottom may not include any legs and the bottom of the container may be made smooth flat and wide enough to be placed on the ground without toppling over. In one embodiment the bottom of the container, may include legs of unequal height, so as to provide a gentle slope to the exiting water.

In another embodiment the bottom of the container may be sloped to provide flow to the exiting water. It is understood that the invention is not limited to arrangement and components as set forth above. The container may be shaped like a bird or any other animal figure for providing a pleasing appearance.

Accordingly, it is a principal object of the invention to provide a portable watering jug with a small pin-sized opening for trickling of water which allows sufficient time for the soil to absorb and produces no waste or runoff.

It is another object of the invention to provide support legs at the bottom for the jug.

It is a further object of the invention to limit the waste of water during drought or water restriction conditions.

Still another object of the invention is to provide a simple twist type delivery pipe and valve combination for regulating the water.

It is an object of the invention to provide improved elements and arrangements thereof for the purposes described which is inexpensive, dependable and fully effective in accomplishing its intended purposes.

These and other objects of the present invention will become readily apparent upon further review of the following specification and drawings.

### BRIEF DESCRIPTION OF THE DRAWINGS

FIG. 1 is an environmental, perspective view of a watering jug for plants with a flat bottom according to the present invention.

FIG. 2 is a sectional view through a center vertical plane of the jug as shown in FIG. 1.

FIG. 3 is an environmental, perspective view of a watering jug with support legs or feet.

FIG. 4 is a sectional view through a center vertical plane of the jug as shown in FIG. 3.

Similar reference characters denote corresponding features consistently throughout the attached drawings.

### DETAILED DESCRIPTION OF THE PREFERRED EMBODIMENTS

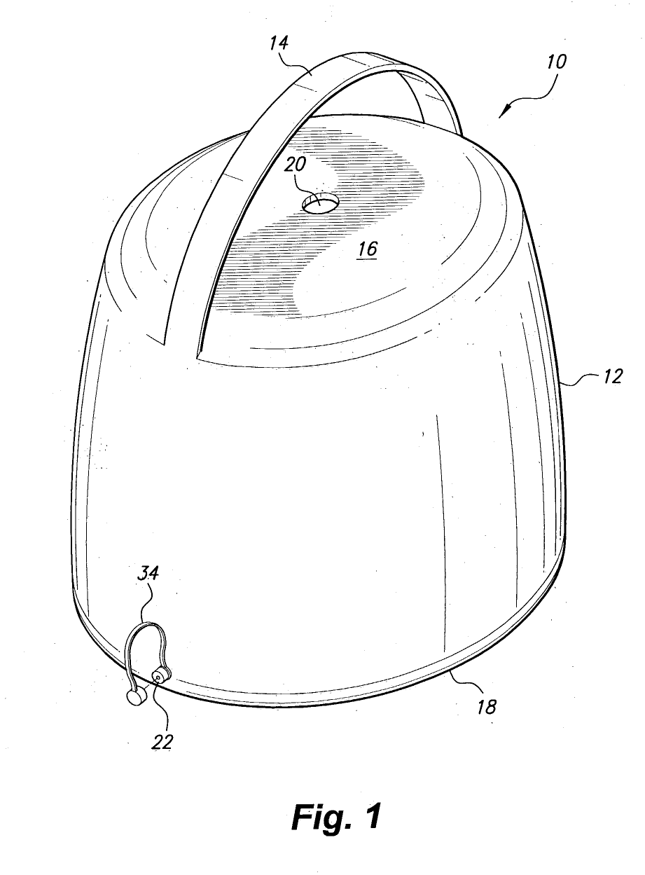

The invention is a watering jug 10 for supplying trickling water to plants, which essentially comprises a container 12. As shown in FIG. 1, the watering jug 10 is lightweight, portable and designed to supply trickling water to plants in pots and in the garden. The rate of trickling is such that it does not lead to water overflow. The main purpose is to feed plants without constantly attending to the watering of plants.

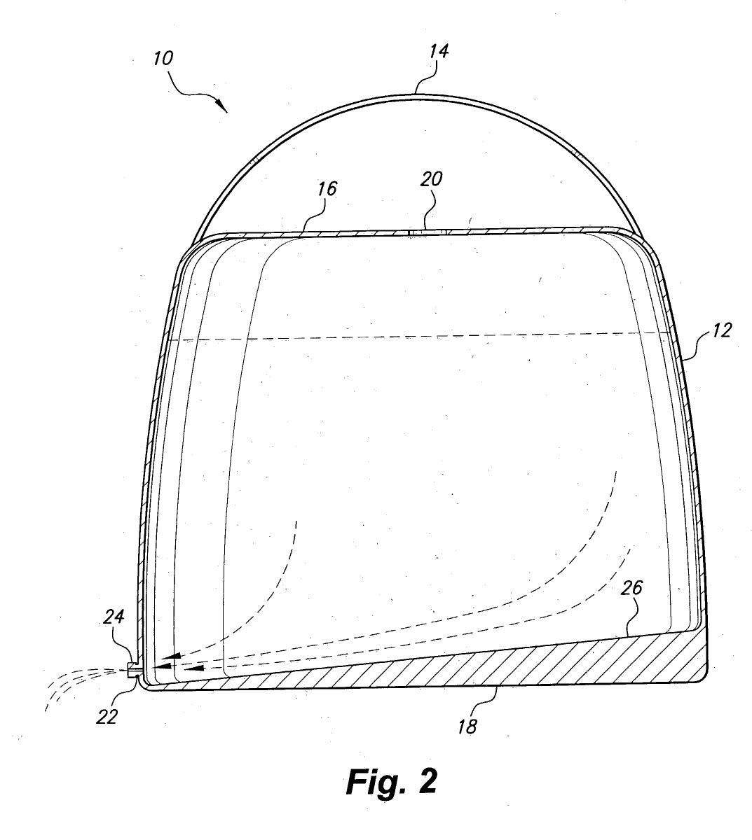

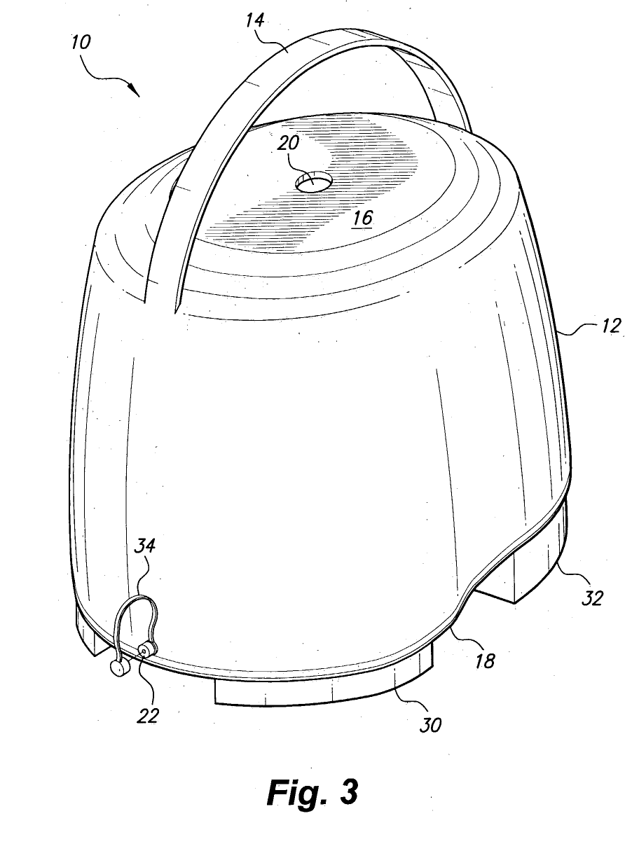

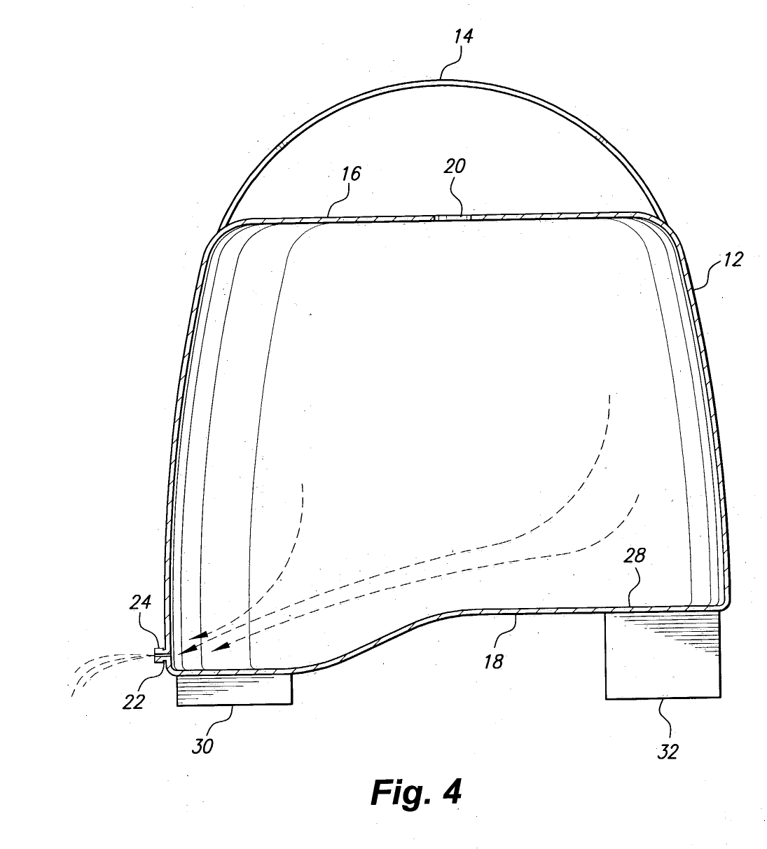

As illustrated in FIGS. 1-4, the watering jug 10 includes a top 16 having a hole 20 in the center located below the handle 14 for filling. A screw type delivery pipe and valve combination 22 with a pin-sized opening 24 is provided at the bottom 18 of the container 12 for opening and closing the flow of water. In one embodiment, as shown in FIG. 2, the interior surface 26 at the bottom 18 of the container 12 is sloped and in the other embodiment, as shown in FIG. 4, the interior surface 28 at the bottom 18 of the container 12 can be stepped to provide a smooth flow to the exiting water. In one embodiment, as shown in FIG. 2, the bottom 18 of the container 12 is flat and wide enough to provide stability to the watering jug 10 while standing upright on the ground, and in the other embodiment, as shown in FIG. 3, the bottom 18 of the container 12 includes a pair of unequal legs or support feet 30 and 32 as illustrated in FIG. 4. The legs 30 and 32 assist in holding the watering jug 10 in an upright position, and raises the height of the delivery pipe and valve combination 22 above a support surface. The watering jug 10 includes a handle 14 in the center for carrying. The delivery pipe and valve combination 22 includes a cap 34 for the opening 24, located at the bottom of the container 12, when not in use.

It is to be understood that the present invention is not limited to the embodiments described above, but encompasses any and all embodiments within the scope of the following claims.

1-5. (canceled)

6. A portable jug for watering plants, comprising:
a container for holding water, said container having a top with a central hole defined therein for use in filling the jug, a bottom and a surrounding side wall extending between the top and the bottom of the container, said bottom including a downwardly sloped interior surface; and
a delivery pipe disposed in the side wall proximate the bottom of the container, said delivery pipe having a pin-sized hole to allow steady trickling of water from the container for watering soil around the plants, said delivery pipe further including a valve for regulating water flow.

7. The portable jug for watering plants according to claim 6, wherein the sloped interior surface of said container bottom has a stepped configuration.

8. The portable jug for watering plants according to claim 6, further including a handle extending over the top of said container.

9. The portable jug for watering plants according to claim 6, wherein said container further includes a plurality of supports at the bottom for maintaining the jug in an upright position.

10. The portable jug for watering plants according to claim 6, wherein said valve includes a twist-type mechanism.

11. The portable jug for watering plants according to claim 6, further including a removal cap for said delivery pipe.

12. The portable jug for watering plants according to claim 6, wherein said container is made of a lightweight material selected from the group consisting of plastic, metal and ceramic.

13. The portable jug for watering plants according to claim 6, wherein said container has a capacity of about 1 to 2 gallons.
